(19) United States
(12) Patent Application Publication
(10) Pub. No.: US 2002/0060232 A1
(43) Pub. Date: May 23, 2002

(54) System for adjustably securing and transporting sporting and utility equipment

(75) Inventors: Brian Stenger, Story, WY (US); John T. Durand, Buffalo, WY (US)

Correspondence Address: Santangelo Law Offices, P.C., Third Floor, 125 South Howes, Fort Collins, CO, 80521, US

(73) Assignee: Big Horn Manufacturing, Story, WY

(21) Appl. No.: 10/005,406

(22) Filed: Nov. 2, 2001

Related U.S. Application Data
(60) Provisional application No. 60/245,301, filed on Nov. 2, 2000.

(51) Int. Cl. B60R 7/00; B60R 9/00; B62J 7/00; B62J 9/00; B62J 11/00

(52) U.S. Cl. 224/401; 224/419; 224/916; 224/913

(57) ABSTRACT

A system and associated methods which may be used to adjustably secure to an all terrain or other vehicle for transport hunting, fishing, and utility equipment, and the like are presented. In several embodiments, a system and methods involving cables, pivot arms, a lever and an elastic cord for compressibly securing between at least one set of biased posts disposed towards opposite ends of a support member are provided. Additionally, a system and associated methods for axially retaining a secured item are presented.

### RELATED APPLICATIONS

This application claims the benefit of U.S. Provisional Application No. 60/245,301 filed on Nov. 2, 2000, hereby incorporated by reference.

### BACKGROUND OF THE INVENTION

This invention relates to a device and associated methods which may be used to adjustably secure items to an all terrain or other vehicle for transport.

### SUMMARY OF THE INVENTION

Users of many existing gun and bow holders often note a number disadvantages such as the device not securely holding the items in place, often resulting in a loose fit and wobbling effect of the equipment when transporting. Some holders may not be structurally sound and may be made of components that tend to wear easily. They may also be more complex to operate. The present invention attempts to solve these and other problems found in existing gun, bow and equipment holders. The present invention presents a utility gear and equipment holding system that may be attachable to an all terrain, off-road, outdoor recreational or other type vehicle and is designed to securely hold equipment and gear such as, for example, a hunting rifle, during transport over rough, bumpy terrain. It may comprise a rigid frame or more generally a support element (that may or may not be rigid, where rigid is defined as essentially inflexible), a lever or more generally a remote movement element that may be levered, and two pairs or merely only one pair of posts or more generally retaining elements that upon manipulation of the movement element, and in response thereto, compress a piece of equipment between the retaining elements. The movement element may be moved in an uncompressed direction and in a compression direction. A biasing effect may be accomplished by an elastic cord or more generally a bias element, in conjunction with a pivot arm(s) and a cable(s), may be used to effect compression of the item to be secured. The invention may also include an axial retention element(s) such as end caps that may, in combination with compression, serve to prevent motion of the secured item in a direction substantially parallel to the axes of the retaining posts. The retaining posts that may compress the secured item may move closer to one another, or farther apart, depending on the operation of the movement element.

### BRIEF DESCRIPTION OF THE FIGURES

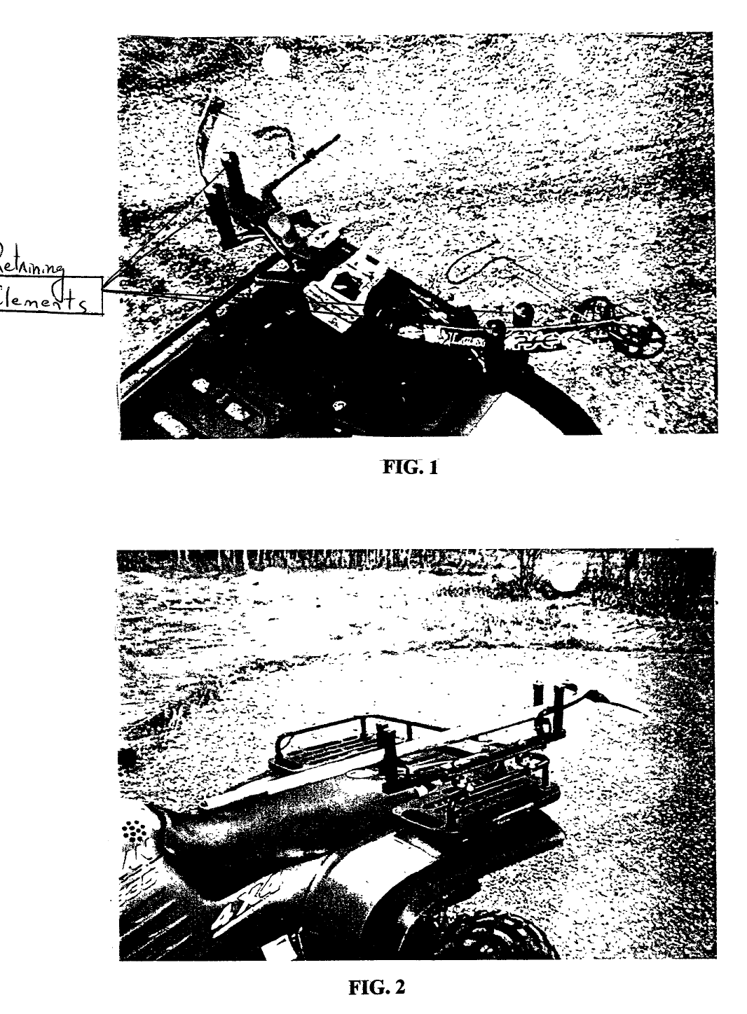

1) FIG. 1 is a top view of the holder securing a bow.

2) FIG. 2 is a side view of the holder securing a shovel.

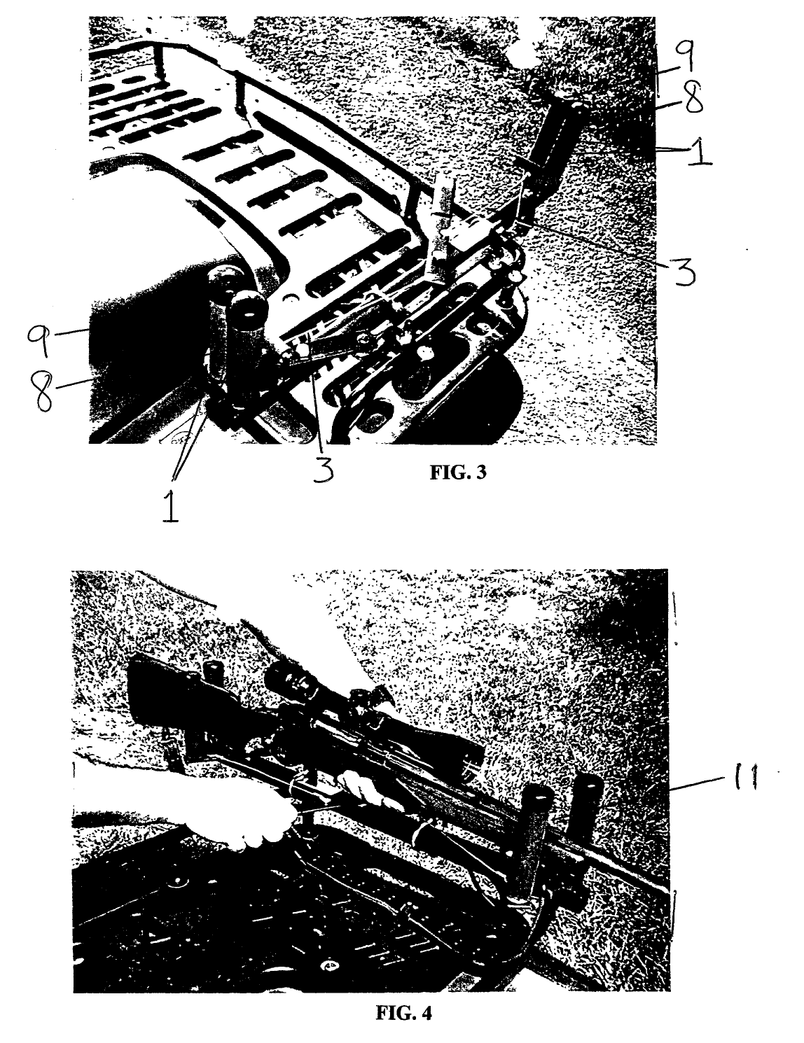

3) FIG. 3 is a top view of the holder securing a gun.

4) FIG. 4 is another view of the holder in the closed position.

5) FIG. 5 is a top view of the holder in the closed position.

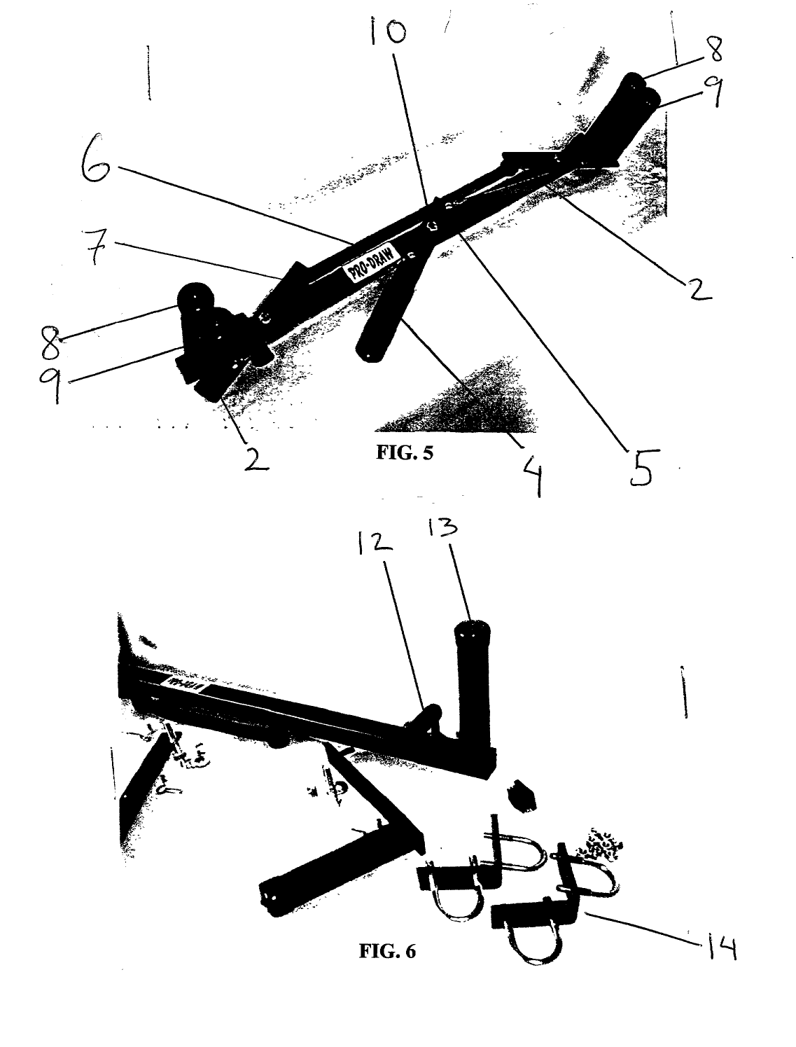

6) FIG. 6 is a view of various components of the holder.

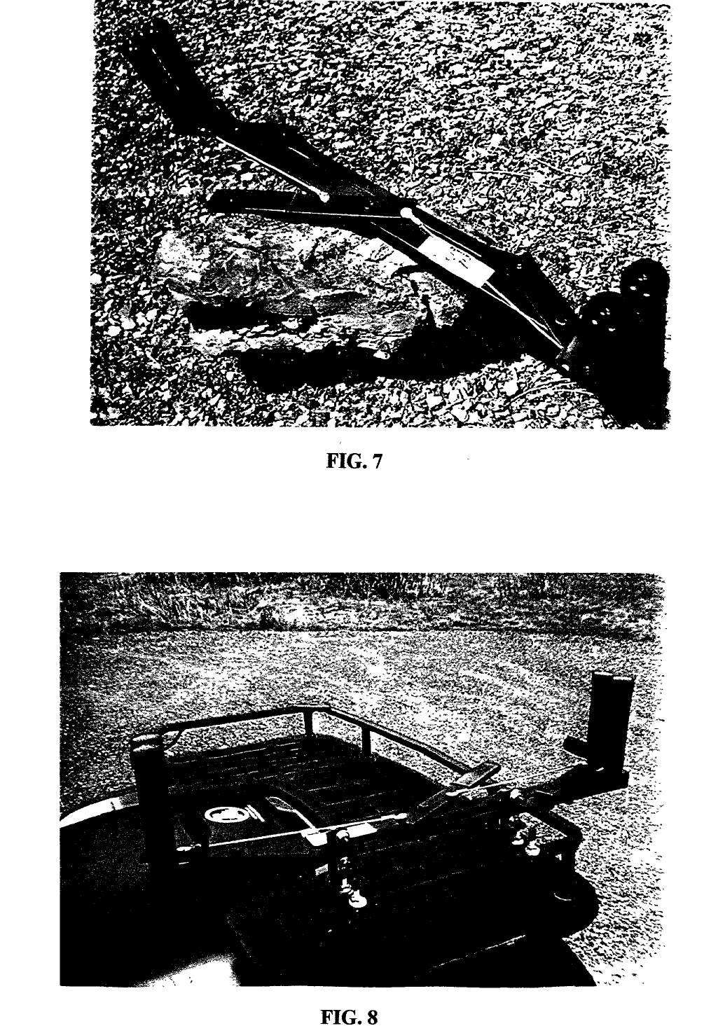

7) FIG. 7 is a view of the holder in the closed position.

8) FIG. 8 is a view of the holder in the closed position and attached to the back of an all-terrain vehicle.

### DETAILED DESCRIPTION OF THE INVENTION

The present invention may be constructed of four posts or more generally retaining elements (1), or merely only two retaining elements, two pivot arms or merely only one pivot arm (2), two cables (3), or only one cable, a plurality of rivets, one lever or remote movement element that may be levered (4), one support element or mainframe (5), and at least one bungee strap or cord, or more generally a bias element (6) that may bias any operational retention elements such as in a compression direction. The support element may be a component that would normally be attached to the vehicle or instead it may be a part of the vehicle to which the holding system is to be attached. The remote movement element may be a lever, as where it were connected to the support element at a point that is not substantially at one half the length of the movement element. By remote it is meant that the movement element is located at some distance from to the moving part that provides the compressive, gripping force, in this invention, the operational retention elements. The system is specifically adapted for use on or with an all terrain vehicle, but may also be used with or on an off-road recreational vehicle, or any other vehicle as well. The present invention may be mechanically operated by the movement element and the bias element that may be attached to each end of the pivot arm(s) by a stud or other connector (7) which goes through a hole in each end of the bias element. Two, or more generally one-half, of the retaining elements may be stationary or fixed (8) relative to the support element and two, or more generally one-half, of them operational (9), or if there are only two total retaining elements, one may be fixed and one may be operational.

The device can be operated by moving, pivotally or otherwise, a remote movement element perhaps about an axis of rotation which may be attached to the center of the support element (10) and may be pivotally movable relative to the support element. Also, the movement element may instead be attached towards the end or any other location on said support element. A pivot arm(s) may be located on the end of the device or support element (or at each end of the device or support element) and may be operated by a cable(s) attached to the movement element and responsive thereto. Any cable(s) may be connected to the remote movement element on opposite sides of the point of attachment of the movement element to the support element and at points that are equidistant from the support member point of attachment. By moving the movement element in an uncompressed direction (i.e., one that is opposite the compression direction of movement urged by the bias element), two pivoting arms may then be moved and operational retaining elements that may be attached to the pivot arms (or that may be merely responsive to the movement of the movement element) may open (or separate from fixed retaining elements in their vicinity), allowing equipment to be easily inserted or removed between (11) the operational retaining elements and the stationary retaining elements. When equipment is inserted it may rest securely on two rests (12) that may be located on the support element on each side of its point of connection to the movement element, or merely on one rest located on the support element. The rests may not move relative to the support element and may thus be fixed. Once the equipment is in place, the movement element may be moved or relaxed in an opposite, compression direction, and a force may thus be applied by the bias element, resulting in a secure grip-like holding of the equipment. Over at least a portion of the movement, all points on the operational retention element(s) may move towards the fixed retention element(s) for substantially equal distances, such that there is no rotation of the operational posts during their movement. Compression, as used herein and in the claims, is defined as pressurization, with or without direct contact between the item pressurized and object creating the pressure. All movement of the movement element may occur in a substantially horizontal plane, where this horizontal plane is defined as a plane that is parallel to that plane defined by the points of contact of the wheels of the vehicle with the ground. The invention may also include an axial retention element(s) such as end caps (13) that may, in combination with compression, serve to prevent motion of the secured item in a direction substantially parallel to the axes of the retaining posts. Attachment components (14) may secure the assembly to a vehicle, an off-road recreational vehicle, or more specifically, an all terrain vehicle and may include several different types of components.

The present invention may be made up of steel, rubber, plastic and cable. Any cables may be made of steel or plastic or nylon, or any other material that is strong enough to resist the compressive effect of the bias element without breaking. Any posts or retaining elements may be made of piping with gum rubber tubing as a sleeve (15), or more generally a yieldable protective material or element, over the piping to protect the item and enhance retention by yieldably engaging it. Any rests may be made of a round stock with gum rubber tubing as a sleeve covering the stock. The mainframe or support element may be constructed of square tubing and may have two plastic end plugs in each end of the support element. The support element may also have attached a relatively small post welded at each end to create a right angle and the two rests may be welded parallel to the post. Each pivot arm may consist of flat steel plates with a plastic sleeve to act as a handle grip. Any cable may be constructed with a stake eye crimp at each end to accept a rivet to attach to a lever or movement element and pivot arms. All post or retaining element tops may be covered with fitted plastic end caps to give the product a finished look and to provide further axial or vertical retention of the secured element. All components may be painted to help reduce exposure to the elements. There may also be included attachment components such as, for example, nuts and U-bolts and elbow joints that maybe used to attach the entire assembly to an all terrain or other vehicle.

What might be significant in one preferred embodiment may include, but not be limited to the following elements:

1) To provide extremely quick removal and insertion of equipment in that the user does not have to undo any Velcro™ or rubber straps as may be seen in existing products.

2) To provide rigid holding capabilities with no wobbling effect of the equipment.

3) To provide an adjustable feature which allows for different sizes of equipment to be securely attached and transported without possible damage due to a loose fit.

4) To provide a sporting and utility equipment holder with greater capabilities than existing holders and to be able to manufacture the holder at a competitive price.

5) To provide quick accessibility to the equipment from a vehicle.

As can be easily understood from the foregoing, the basic concepts of the present invention may be embodied in a variety of ways. It involves both holding methods as well as devices to accomplish the appropriate holding. In this application, the holding methods are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims in this application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon for support for the claims in this application.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “holder” should be understood to encompass disclosure of the act of “holding”—whether explicitly discussed or not—and, conversely, were there effectively disclosure of the act of “holding”, such a disclosure should be understood to encompass disclosure of a “holder” and even a “means for holding” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of references or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim at least: i) each of the holding devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, and ix) methods and apparatuses substantially as described hereinbefore and with reference to any of the accompanying examples, x) the various combinations and permutations of each of the elements disclosed, and xi) each potentially dependent claim or concept as a dependency on each and every one of the independent claims or concepts presented. In this regard it should be understood that for practical reasons and so as to avoid adding potentially hundreds of claims, the applicant may eventually present claims with initial dependencies only. Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept. Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

what is claimed is:

1. A method for securing an item to an outdoor recreational vehicle, comprising the steps of:
a. establishing a support element on said vehicle;
b. establishing at least one fixed retention element fixed relative to said support element;
c. biasing at least one operational retention element in a compression direction;
d. pivotally moving a movement element in a first pivotal direction;
e. remotely moving said at least one operational retention element in an uncompressed direction in response to said step of pivotally moving said movement element in said first pivotal direction;
f. positioning said item between said at least one fixed retention element fixed relative to said support element and said at least one operational retention element;
g. pivotally relaxing said movement element in a second pivotal direction opposite said first pivotal direction;
h. remotely moving said at least one operational retention element in a compression direction in response to said step of pivotally relaxing said movement element in said second pivotal direction; and
i. compressibly retaining said item between said fixed retention element and said operational retention element.

2. A method for securing an item to an outdoor recreational vehicle as in claim 1, wherein said step of remotely moving said at least one operational retention element in a compression direction further comprises the step of substantially equally moving all points along said operational retention element towards said fixed retention element.

3. A method for securing an item to an outdoor recreational vehicle as in claim 1 and further comprising the step of moving at least one cable in response to said step of pivotally moving a movement element in a first pivotal direction.

4. A method for securing an item to an outdoor recreational vehicle as in claim 1 wherein said step of pivotally moving a movement element in a first pivotal direction comprises the step of levered moving said movement element.

5. A method for securing an item to an outdoor recreational vehicle as in claim 1 wherein said step of positioning said item between said at least one fixed retention element fixed relative to said support element and said at least one operational retention element comprises the step of placing said item on at least one fixed support rest fixed relative to said support member.

6. A method for securing an item to an outdoor recreational vehicle as in claim 1 and further comprising the step of axially retaining said item to be secured.

7. A method for securing an item to an outdoor recreational vehicle as in claim 1 wherein said step of biasing comprises the step of elastic cord biasing said at least one operational retention element

8. A method for securing an item to an outdoor recreational vehicle as in claim 1 wherein said step of establishing a support element on said vehicle comprises the step of attaching said support element to said vehicle.

9. A method for securing an item to an outdoor recreational vehicle as in claim 1 wherein said step of compressibly retaining said item comprises the step of yieldably retaining said item through direct contact between said item and at least one protective surface.

10. A method for securing an item to an outdoor recreational vehicle as in claim 4 and further comprising the step of pivotally moving at least one pivot arm in response to said step of pivotally moving a movement element in a first pivotal direction.

11. A method for securing an item to an outdoor recreational vehicle as in claim 1 wherein said step of remotely moving said at least one operational retention element in an uncompressed direction comprises the step of remotely moving at least two operational retention elements in an uncompressed direction.

12. A method for securing an item to an outdoor recreational vehicle as in claim 10 and further comprising the steps of:
a. substantially equally moving all points along said operational retention element towards said fixed retention element;
b. moving a first cable attached to a first pivotal side of said remote movement element in a first pivotal direction;
c. moving a second cable attached to a second pivotal side of said remote movement element in a second pivotal direction; and
c. placing said item on at least one fixed support rest fixed relative to said support member.

13. A system for securing an item to an outdoor recreational vehicle, comprising:
a. a support element;
b. at least one fixed retention element fixed relative to said support element;
c. a remote movement element pivotally movable relative to said support element;
d. at least one operational retention element responsive to said remote movement element;
e. a bias element to which said operational retention element is responsive; and
f. at least one attachment component connectable to said support element.

14. A system for securing an item to an outdoor recreational vehicle as in claim 13, further comprising at least one cable movable relative to said remote movement element.

15. A system for securing an item to an outdoor recreational vehicle as in claim 13, wherein said remote movement element is pivotally connected to said support element.

16. A system for securing an item to an outdoor recreational vehicle as in claim 15, wherein said remote movement element is pivotally connected to said support element at a point that is located at substantially one half the length of said support element.

17. A system for securing an item to an outdoor recreational vehicle as in claim 13, wherein said at least one fixed retention element is attached to said support element at substantially the end of said support element.

18. A system for securing an item to an outdoor recreational vehicle as in claim 14, wherein said at least one cable comprises a first cable and a second cable.

19. A system for securing an item to an outdoor recreational vehicle as in claim 18, wherein said first cable and said second cable are connected to said movement element on opposite sides of an axis of rotation of said remote movable element.

20. A system for securing an item to an outdoor recreational vehicle as in claim 19, wherein said first cable and said second cable are connected to said remote movement element at points that are equidistant from said axis of rotation of said remote movement element.

21. A system for securing an item to an outdoor recreational vehicle as in claim 13 further comprising at least one fixed rest fixed relative to said support element.

22. A system for securing an item to an outdoor recreational vehicle as in claim 13 wherein said bias element is an elastic cord.

23. A system for securing an item to an outdoor recreational vehicle as in claim 13 further comprising at least one axial retention element.

24. A system for securing an item to an outdoor recreational vehicle as in claim 13 wherein said at least one fixed retention element and said at least one operational retention element comprise a yieldable protective element.

25. A system for securing an item to an outdoor recreational vehicle as in claim 13 further comprising at least one pivot arm pivotally movable relative to said support element.

26. A system for securing an item to an outdoor recreational vehicle as in claim 18 wherein said at least one operational retention element responsive to said remote movement element comprises two operational retention elements.

27. A system for securing an item to an outdoor recreational vehicle, comprising:
a. a support element;
b. a singularly controllable remote movement element pivotally movable relative to said support element;
c. two fixed retention elements fixed relative to said support element;
d. two operational retention elements responsive to said singularly controllable remote movement element in an uncompressed direction;
e. a linked motion mechanism connected to said two operational retention elements and said singularly controllable remote movement element;
f. at least one bias element to which said two operational retention elements are responsive in a compressive direction that is opposite said uncompressed direction; and
g. at least one attachment component connectable to said support element.
